(19) United States
(12) Patent Application Publication
(10) Pub. No.: US 2012/0221731 A1
(43) Pub. Date: Aug. 30, 2012

(54) COMPUTING DEVICE AND METHOD FOR SCHEDULING SERVICE APPLICATIONS

(75) Inventors: ZHI-HONG LI, Shenzhen City (CN); CHIEN-FA YEH, Tu-Cheng (TW); CHUNG-I LEE, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/338,275

(22) Filed: Dec. 28, 2011

(30) Foreign Application Priority Data
Feb. 24, 2011 (CN) 201110044476.1

(51) Int. Cl. G06F 15/173

(52) U.S. Cl. 709/226

(57) ABSTRACT

A method for scheduling service applications is applied in a computing device. The method creates a software interface and sets a scheduled time and operation parameters of a service application. The software interface is called and bound to the service application. The service application is added to a scheduling queue. At the scheduled time, the service application is selected from the scheduling queue and executed according to the operation parameters of the service application.

### BACKGROUND

1. Technical Field

Embodiments of the present disclosure relate to systems and methods for managing service applications, and particularly to a computing device and method for scheduling service applications of the computing device.

2. Description of Related Art

A service application may be used to perform a specific task such as to download a file from a network. Users may schedule a plurality of service applications to be executed at scheduled times. Sometimes the service applications need to be adjusted or modified. However, it is inconvenient to adjust or modify individual service applications independently after the service applications have been scheduled.

### BRIEF DESCRIPTION OF THE DRAWINGS

FIG. 1 is a block diagram of one embodiment of a computing device for scheduling service applications.

FIG. 2 is a block diagram of one embodiment of a scheduling unit included in the computing device of FIG. 1

FIG. 3 is a flowchart of one embodiment of a method for scheduling service applications.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

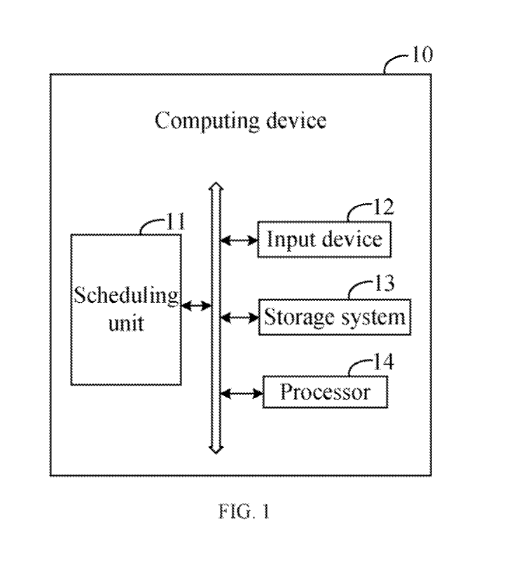

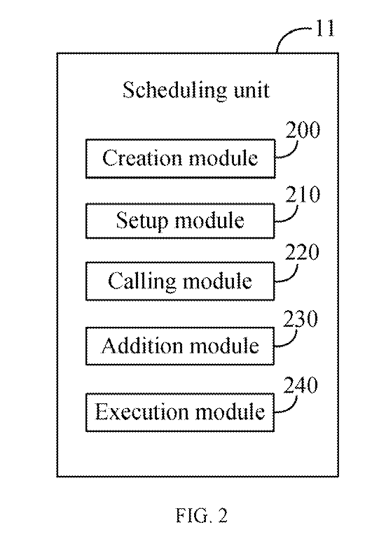

FIG. 1 is a block diagram of one embodiment of a computing device 10 for scheduling service applications. Each of the service applications performs a specific task such as to download files from a network and needs to be executed at a predetermined time. In one embodiment, the computing device 10 may include a scheduling unit 11, an input device 12, a storage system 13, and at least one processor 14. The scheduling unit 11 includes a number of function modules (shown in FIG. 2). The function modules may comprise computerized codes in the form of one or more programs that are stored in the storage system 13. The computerized codes includes instructions that are executed by the at least one processor 14 to provide functions for the modules. In one embodiment, the storage system 13 may be an internal storage device, such as a random access memory (RAM) for temporary storage of information, and/or a read only memory (ROM) for permanent storage of information. In some embodiments, the storage system 13 may also be an external storage device, such as an external hard disk, a storage card, or other data storage medium.

FIG. 2 is a block diagram of one embodiment of the scheduling unit 11 included in the computing device 10 of FIG. 1. The scheduling unit 11 includes a creation module 200, a setup module 210, a calling module 220, an addition module 230, and an execution module 240.

The creation module 200 creates a software interface that defines a method to execute the service applications of the computing device 1. It may be understood that a software interface is a data interface that interacts with applications or programs running on an operating system of the computing device 1 that may need to interact via stream or methods. Software interfaces can also provides access to computer resources (such as memory, CPU, storage, etc.).

The setup module 210 is used to set configuration information of the service application. The configuration information of the service application may include a scheduled time for execution of the service application and operation parameters of the service application. In one embodiment, the service application is an XQuery script. The operation parameters may include a network agent, a network user name, a network password, a database address, a database user name, and a database password. The setup module 210 may set the configuration information of the service application according to user input via the input device 12.

The calling module 220 calls the software interface and binds the software interface to the service application. Therefore, the service application is executable through the software interface.

The addition module 230 adds the service application to a scheduling queue that consists of the service applications.

The execution module 240 selects the service application from the scheduling queue at the scheduled time of the service application, and executes the service application according to the operation parameters of the service application. In one embodiment, the execution module 240 accesses a network using the network agent, the network user, and the network password, and downloads data from a database with the database address via the network using the database user name and the database network password.

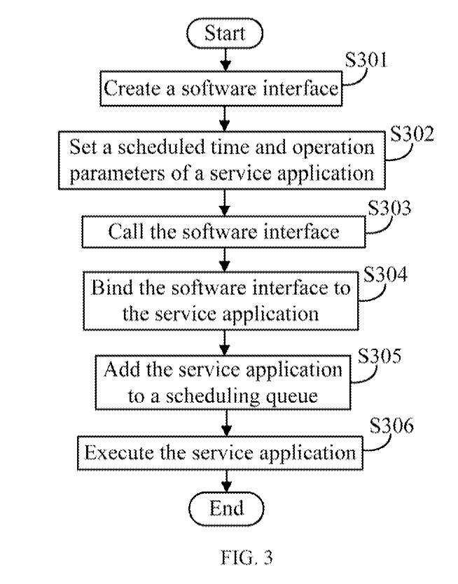

FIG. 3 is a flowchart of one embodiment of a method for scheduling service applications of a computing device, such as that of FIG. 1. Depending on the embodiments, additional blocks may be added, others removed, and the ordering of the blocks may be changed.

In block S301, the creation module 200 creates a software interface that defines a method to execute the service applications of the computing device 1.

In block S302, the setup module 210 sets a stare time for execution of a service application and operation parameters of the service application. In one embodiment, the service application is an XQuery script. The operation parameters may include a network agent, a network user name, a network password, a database address, a database user name, and a database password.

In block S303, the calling module 220 calls the software interface when the service application needs to be scheduled.

In block S304, the calling module 220 binds the software interface to the service application. As such, the service application is executable through the software interface.

In block S305, the addition module 230 adds the service application to a scheduling queue that consists of the service applications.

In block S306, the execution module 240 selects the service application from the scheduling queue at the scheduled time of the service application, and executes the service application according to the operation parameters of the service application.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device for scheduling service applications, the computing device comprising:
a storage system;
at least one processor;
a scheduling unit comprising one or more computerized codes that are stored in the storage system and executed by the at least one processor, the one or more computerized codes comprising:
a creation module that creates a software interface that defines a method to execute the service applications;
a setup module that sets a scheduled time and operation parameters of a service application;
a calling module that calls the software interface and bind the software interface to the service application;
an adding module that adds the service application to a scheduling queue; and
an execution module that selects the service application from the scheduling queue at the scheduled time of the service application, and executes the service application according to the operation parameters of the service application.

2. The computing system of claim 1, wherein the service application is an XQuery script.

3. The computing system of claim 1, wherein the operation parameters comprise a network agent, a network user name, a network password, a database address, a database user name, and a database password.

4. The computing system of claim 1, wherein the setup module sets the scheduled time and the operation parameters according to user input from an input device of the computing device.

5. A computer-based method for scheduling service applications of a computing device, the method comprising:
creating a software interface that defines a method to execute the service applications;
setting scheduled time and operation parameters of a service application;
invoking the software interface and binding the software interface to the service application;
adding the service application to a scheduling queue; and
selecting the service application from the scheduling queue at the scheduled time of the service application, and executing the service application according to the operation parameters of the service application.

6. The method of claim 5, wherein the service application is an XQuery script.

7. The method of claim 5, wherein the operation parameters comprise a network agent, a network user name, a network password, a database address, a database user name, and a database password.

8. The method of claim 5, wherein the scheduled time and the operation parameters are set according to user input from an input device of the computing device.

9. A non-transitory computer-readable medium having stored thereon instructions that, when executed by a processor of a computing device, cause the computing device to execute a method for scheduling service applications, the method comprising:
creating a software interface that defines a method to execute the service applications;
setting scheduled time and operation parameters of a service application;
invoking the software interface and binding the software interface to the service application;
adding the service application to a scheduling queue; and
selecting the service application from the scheduling queue at the scheduled time of the service application, and executing the service application according to the operation parameters of the service application.

10. The medium of claim 9, wherein the service application is an XQuery script.

11. The medium of claim 9, wherein the operation parameters comprise a network agent, a network user name, a network password, a database address, a database user name, and a database password.

12. The medium of claim 9, wherein the scheduled time and the operation parameters are set according to user input from an input device of the computing device.
